(19) United States
(12) Patent Application Publication
(10) Pub. No.: US 2003/0184093 A1
(43) Pub. Date: Oct. 2, 2003

(54) Adjustable meter loop assembly

(76) Inventors: Brian L. Schubert, Binghamton, NY (US); John F. Hunt, Owego, NY (US); Michael D. Eastman, Endwell, NY (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/108,704

(22) Filed: Mar. 29, 2002

(51) Int. Cl. A47F 5/00; F16L 25/00

(52) U.S. Cl. 285/420; 248/125.1

(57) ABSTRACT

An adjustable meter loop assembly that is attachable to a variety of gas meters. The adjustable meter loop assembly includes a first pipe, a second pipe, and a meter bar assembly connecting the first and second pipes. The first pipe is connected to gas supply (inlet) piping. The second pipe is connected to service (outlet) piping that runs to the residence or commercial site. The meter bar assembly includes a first member connected to the first pipe, and second and third members having first and second ends. The first ends of the second and third members are connected to the first member. The second end of the second member is connected to the second end of the third member to form an area for receiving the second pipe.

### FIELD OF THE INVENTION

The present invention relates to an adjustable meter loop assembly. More particularly, the present invention relates to a meter bar assembly that is adjustable to facilitate connecting to a variety of differently sized gas meters and to existing piping. Still more particularly, the present invention relates to a meter bar assembly having a laterally adjustable meter bar and clamps for rotatably and vertically adjusting piping.

### BACKGROUND OF THE INVENTION

Meter loop assemblies are used to install gas meters in gas supply piping at residences and small commercial sites having small to low pressure gas piping. Meter loop assemblies have inlets that connect to existing gas supply piping and outlets that connect to gas service piping that supply gas to the residences or commercial sites. Regulators, gas meters and other devices are installed as part of the meter loop assemblies to regulate, measure or perform any other action with respect to the gas flowing through the meter loop assembly.

Existing meter loop assemblies have meter bars that are manufactured for a single, predetermined gas meter configuration. Gas meters are available that have varying distances between the inlet and outlet connections Since gas meters are not standardized, a unique meter loop assembly is required to be manufactured for each different gas meter configuration. This results in a large inventory of meter loop assemblies being required to connect to the many different gas meters. Therefore, a need exists for a meter loop assembly that is adjustable to receive a variety of gas meters.

Connecting to existing gas lines with existing meter loop assemblies is difficult. Generally, the meter loop assembly piping connections are rigidly fixed so that the meter loop assembly cannot be adjusted to facilitate connecting to existing piping. Additional piping components are required to make the connection between the meter loop assembly and the existing pipe. Moreover, due to the non-alignment between existing gas piping and the meter loop assembly connections, undue strain is often introduced on the connections. Therefore, a need exists for a meter loop assembly that is adjustable to facilitate connecting to existing gas piping without introducing excessive strain on the connections.

Examples of existing adjustable meter bar assemblies are disclosed in the following references: U.S. Pat. Nos. 1,795,019 to Freeman; 1,795,020 to Freeman; 1,936,852 to Mueller; and 1,887,999 to Fow.

Therefore, a need there is a continuing need to provide improved adjustable meter bar assemblies.

### SUMMARY OF THE INVENTION

Accordingly, it is an objective of the present invention to provide a meter loop assembly having a meter bar assembly that is adjustable to receive a variety of differently configured gas meters, thereby reducing inventory.

Another objective of the present invention is to provide a meter loop assembly having a meter bar assembly that is adjustable to facilitate connecting to existing piping, thereby reducing installation time and effort without introducing excessive strain on the piping connections.

The foregoing objectives are basically attained by providing a meter bar assembly including a first member connected to a first pipe, and second and third members having first and second ends. The first ends of the second and third members are connected to the first member. The second end of the second member is connected to the second end of the third member to form an area for receiving a second pipe. The second and third members are movable relative to the first member, thereby providing a meter bar assembly that is attachable to a variety of gas meter configurations. The second pipe is vertically movable and rotatable within the area between the second and third members, thereby facilitating connecting with existing piping.

Other objects, advantages and salient features of the invention will become apparent from the following detailed description, which, taken in conjunction with the annexed drawings, discloses a preferred embodiment of the invention.

### BRIEF DESCRIPTION OF THE DRAWINGS

Referring now to the drawings that form a part of the original disclosure:

FIG. 1 is a front elevational view of an adjustable meter loop assembly according to the present invention;

FIG. 2 is a bottom plan view of the adjustable meter loop assembly of FIG. 1;

FIG. 3 is a perspective view of the meter bar of the adjustable meter loop assembly of FIG. 1;

FIG. 4 is a perspective view in partial cross section of the meter bar of the adjustable meter loop assembly of FIG. 1;

FIG. 5 is a rear perspective view of clamping members of the adjustable meter loop assembly;

FIG. 6 is a side elevational view of the 180 degree bend in the inlet pipe of the adjustable meter loop assembly;

FIG. 7 is a front elevational view of an adjustable meter loop assembly according to a second embodiment of the present invention;

FIG. 8 is a side elevational view of the adjustable meter loop assembly of FIG. 7;

FIG. 9 is a bottom view in partial cross section of the adjustable meter loop assembly taken along line 9-9 of FIG. 7;

FIG. 10 is front elevational view of an adjustable meter loop assembly according to a third embodiment of the present invention;

FIG. 11 is a side elevational view of the adjustable meter loop assembly of FIG. 10;

FIG. 12 is a side elevational view of the meter bar secured to the first pipe taken along line 12-12 of FIG. 7;

FIG. 13 is a side elevational view of a clamp used to secure the second pipe to the meter bar; and

FIG. 14 is a bottom plan view of the meter bar assembly taken along line 14-14 of FIG. 10.

### DETAILED DESCRIPTION OF THE INVENTION

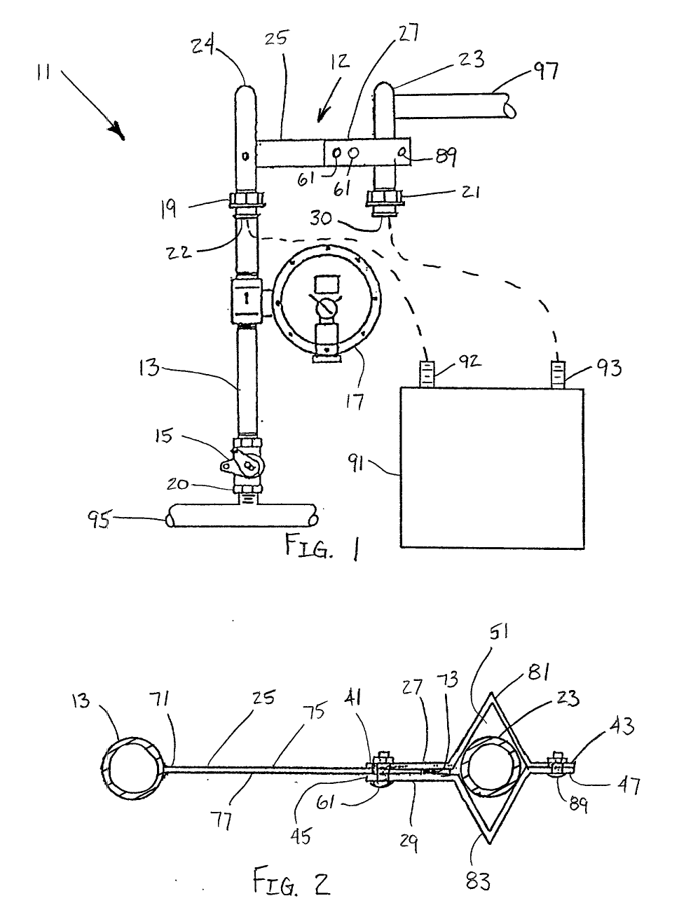

As shown in FIGS. 1-6, the present invention relates to an adjustable meter loop assembly 11 for a gas meter 91. The adjustable meter loop assembly 11 includes a first pipe 13, a second pipe 23, and a meter bar assembly 12 connecting the first and second pipes. The first pipe 13 is connected to gas supply (inlet) piping 95. The second pipe 23 is connected to service (outlet) piping 97 that runs to the residence or commercial site. Although the present invention is described with reference to gas piping systems, the present invention is not limited to such use.

As shown in FIG. 1, the first pipe 13 has first and second ends 20 and 22, respectively. The first end 20 of the first pipe 13 is connected to the existing gas supply piping 95. The second end 22 of the first pipe 13 has a first connector 19 for connecting to the inlet 92 of a gas meter 91. Preferably, the first connector 19 is a swivel nut connector. An inlet valve 15 in first pipe 13 allows the flow of gas to be stopped to perform maintenance downstream of the inlet valve. A regulator 17 is located in first pipe 13 to measure the pressure within the first pipe. Preferably, first pipe 13 is substantially J-shaped, as shown in FIG. 6. First pipe 13 has a 180 degree bend 24 to facilitate connecting the connector 19 of the first pipe to the inlet 92 of the gas meter 91.

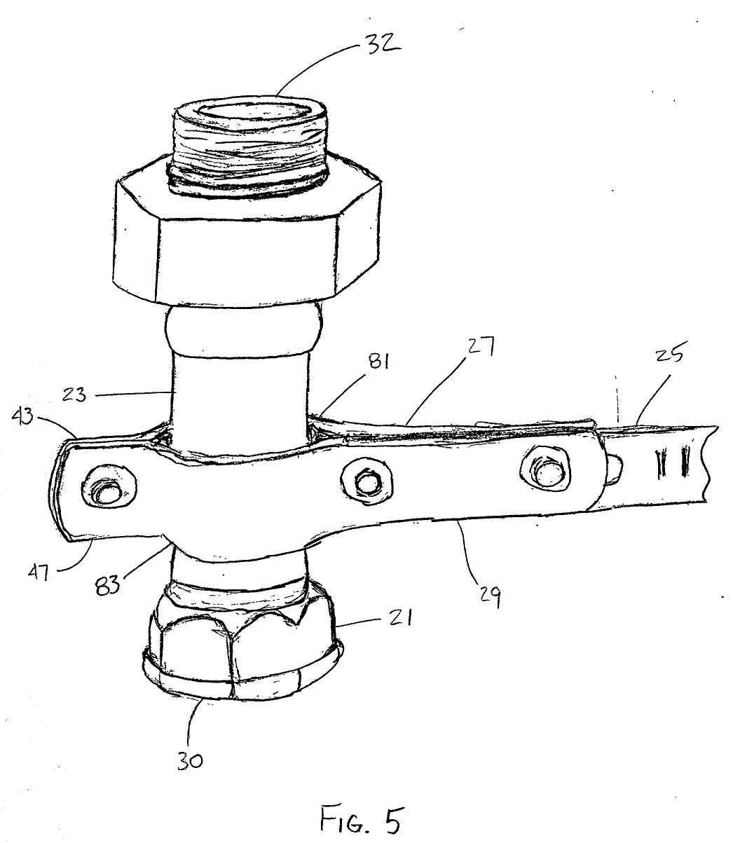

The second pipe 23 has first and second ends 30 and 32, respectively, as shown in FIGS. 1, 4 and 5. The first end 30 of the second pipe 23 has a second connector 21 for connecting to the outlet 93 of the gas meter 91. Preferably, the second connector 21 is a swivel nut connector. The second end 32 of the second pipe 23 is connected to service piping 97 that provides gas to the residence or commercial site after the gas has passed through the meter. Preferably, as shown in FIG. 1, the second pipe 23 is J-shaped. However, the second pipe 23 may be of any configuration to facilitate connecting to existing service piping 97, such as a vertical run of pipe shown in FIGS. 5, 7 and 10.

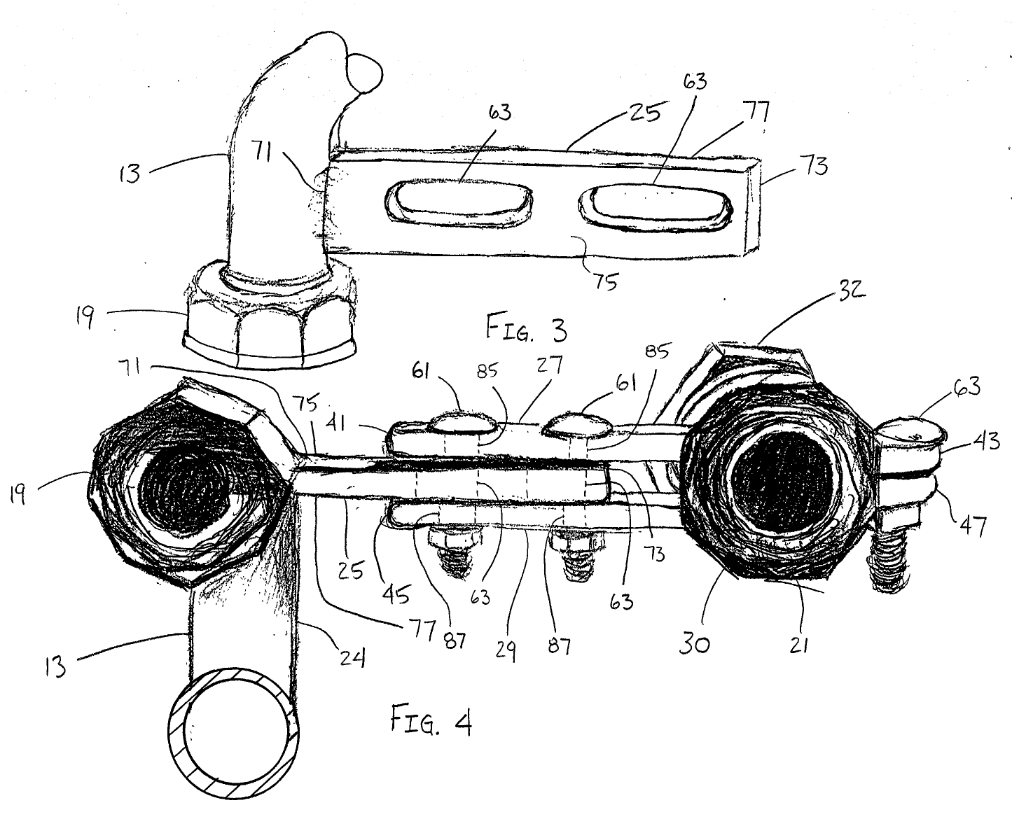

A meter bar assembly 12 connects first and second pipes 13 and 23, as shown in FIGS. 1, 2, 4, 5 and 6. The meter bar assembly 12 includes first, second and third members 25, 27 and 29, respectively. The first member (meter bar) 25 has a first end 71 and a second end 73, and first and second opposing surfaces 75 and 77, respectively. The first end 71 of first member 25 is connected to first pipe 13. Preferably, the first member 25 is welded to the first pipe 13, as shown in FIG. 3, although any suitable means of connection may be used. The first member 25 has at least one first opening 63. Preferably, the first member 25 has two elongated first openings 63, as shown in FIG. 3. Preferably, the first member 25 is made of steel.

The second member 27 has first and second ends 41 and 43, respectively. The first end 41 of the second member 29 is connected to the first member 25. The second member 27 has an arcuate portion 81. The second member 27 has at least one second opening 85 and a fourth opening 86. Preferably, the second member 27 has two second openings 85, as shown in FIG. 5.

The third member 29 has first and second ends 45 and 47, respectively. The first end 45 of the third member 29 is connected to the first member 25. The third member 29 has an arcuate portion 83. The third member 29 has at least one third opening 87 and a fifth opening 88. The second ends 43 and 47 of the second and third members 27 and 29, respectively, are connected together. When the second ends 43 and 47 of the second and third members 27 and 29, respectively, are joined together an area 51 is formed between the second and third members to receive second pipe 23.

### Assembly and Disassembly

The adjustable meter loop assembly 11 is shown fully assembled in FIG. 1. The first end 30 of the first pipe 13 is connected to the existing supply piping 95. The first pipe 13 may have an inlet valve 15 and a regulator 17.

The first member 25 is connected to the first pipe 13, preferably by welding. The at least one openings 63, 85 and 87 in the first, second and third members 25, 27 and 29, respectively, are aligned and a first fastener 61 is inserted through the aligned openings to attach the second and third members to the first member. Preferably, the at least one first opening 63 in the first member 25 is elongated, such that the second and third members 27 and 29 may be moved laterally relative to the first member to adjust the distance between the first connector 19 and the second connector 21.

The second end 43 of the second member 27 is connected to the second end 47 of the third member 29. The fourth opening 86 in the second member 27 is aligned with the fifth opening 88 in the third member 29. A second fastener 89 is inserted through the aligned fourth and fifth openings 86 and 88 to secure the second and third members 27 and 29 together. An area 51 is formed between the arcuate portions 81 and 83 of the second and third members 27 and 29. The area 51 receives the second pipe 23. Tightening fastener 89 secures the second pipe 23 in the area 51 between second and third members 27 and 29. The second pipe 23 may be rotated or moved vertically relative to the second and third members 27 and 29 to facilitate connecting to meter 91 and to service piping 97 by loosening the second fastener 89.

By varying the distance between the first and second connectors 19 and 21, various sized gas meters 91 may be received by the adjustable meter bar assembly 12. The first fastener 61 is loosened and the second and third members 27 and 29 are moved laterally relative to the first member 25 to align the first and second connectors 19 and 21 with the meter inlet and outlet 92 and 93, respectively. The second fastener 89 is loosened to vertically align the second connector 21 with the meter outlet 93. The inlet 92 of the gas meter 91 is connected to the first connector 19 and the outlet 93 is connected to the second connector 21. The first fastener 61 is then retightened. The second pipe 23 is then rotated within space 51 to align the second end 32 of the second pipe with the service piping 97. The second pipe 23 is then connected to the service piping 97 and the second fastener 89 is retightened to secure the second pipe between the second and third members 27 and 29.

Second Embodiment

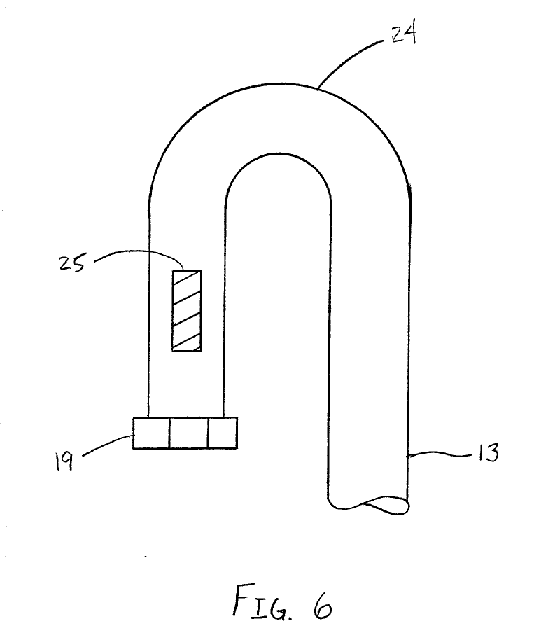

FIGS. 7-9 show an adjustable meter loop assembly according to a second embodiment of the present invention. The same reference numerals are used in the description of the second embodiment to indicate parts similar to those of the first embodiment.

As shown in FIGS. 7-9, the second embodiment of the present invention relates to an adjustable meter loop assembly 111 for a gas meter (see FIG. 1). The adjustable meter loop assembly 111 includes a first pipe 13, a second pipe 23, and a meter bar assembly 112 connecting the first and second pipes. A first member 125 is connected to the first pipe 13. A second member 131 has first and second ends 133 and 135, respectively. The first end 133 is connected to the first member 125, and the second end 135 is connected to the first member. An area 141 is formed between the first and second members 125 and 131 for receiving a second pipe 23.

A meter bar assembly 112 according to a second embodiment of the present invention connects first and second pipes 13 and 23, as shown in FIGS. 7-9. The meter bar assembly 112 includes first and second members 125 and 131, respectively. The first member (meter bar) 125 has a first end 171 and a second end 173, and first and second opposing surfaces 175 and 177, respectively. The first end 171 of first member 125 is connected to first pipe 13. Preferably, the first member 125 is welded to the first pipe 13, as shown in FIG. 7, although any suitable means of connection may be used. The first member 125 has at least one first opening 163. Preferably, the first member 125 has two elongated fist openings 63, as shown in FIGS. 7 and 9. Preferably, the first member 125 is made of steel.

The second member (clamping member) 131 has first and second ends 133 and 135, respectively. The first end 131 of the second member 131 is connected to the first member 125. The second member 131 has an arcuate portion 181. The second member 131 has at least one second opening 185. Preferably, the second member 131 has two second openings 185, as shown in FIGS. 7 and 9.

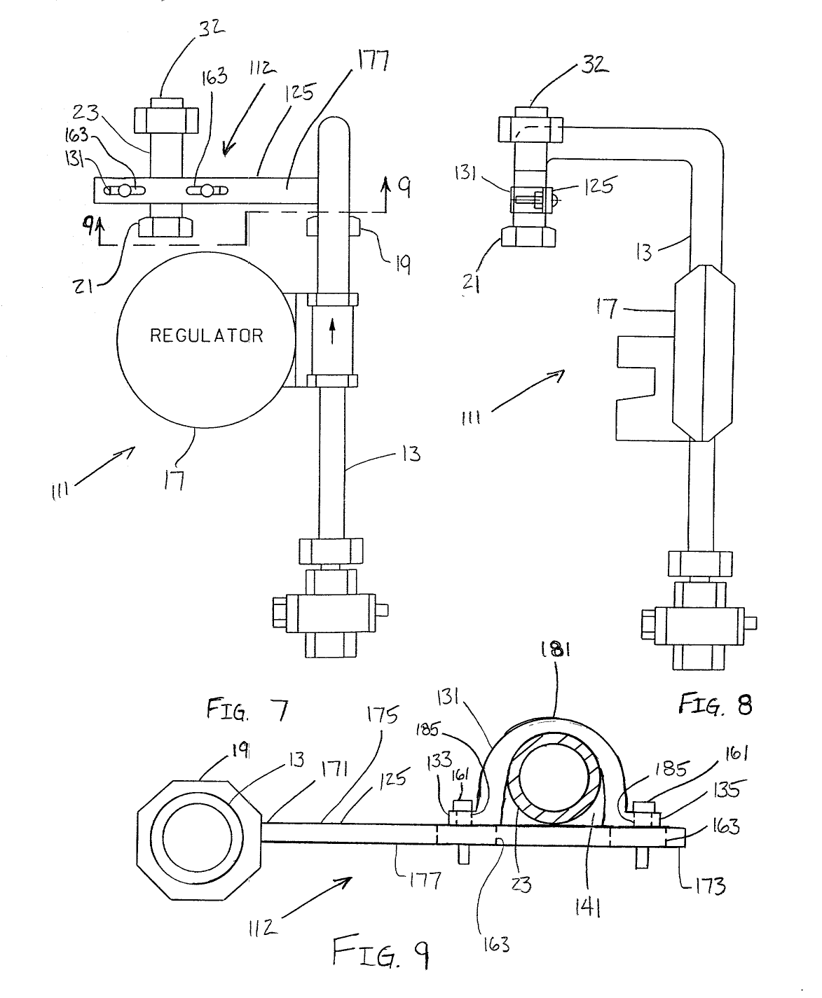

The adjustable meter loop assembly 111 is shown fully assembled in FIGS. 7 and 8. The first member 125 is connected to the first pipe 13, preferably by welding. The at least one second opening 185 in second member 131 is aligned with the at least one first opening 163 in first member 125 and a first fastener 161 is inserted through the aligned openings to secure the second member to the first member. Preferably, the at least one first opening 163 in first member 125 is elongated, such that the second member 131 may be moved laterally relative to the first member to adjust the distance between the first connector 19 and the second connector 21 Preferably, first member 125 and second member 131 each have two openings 163 and 185, respectively, that receive fasteners 161 to secure the second member to the first member.

As shown in FIG. 9, an area 141 is formed between the arcuate portion 181 of the second member 131 and the first member 125. Area 141 receives second pipe 23. Tightening fasteners 161 secures the second pipe 23 in the area 141 between first and second members 125 and 131. The second pipe 23 may be rotated or moved vertically relative to the first and second members 125 and 131 to facilitate connecting to a gas meter (FIG. 1) and to service piping (FIG. 1) by loosening one of the fasteners 161.

By varying the distance between the first and second connectors 19 and 21, various sized gas meters may be received by the adjustable meter bar assembly 112. First fasteners 161 are loosened and the second member 131 is moved laterally relative to first member 125 to align first and second connectors 19 and 21 with the inlet and outlet of the gas meter. This allows the meter bar assembly 111 to accommodate any size gas meter. Furthermore, when first fasteners 161 are loosened, second pipe 23 is movable vertically to align second connector 21 with the meter outlet and with gas service piping (97 in FIG. 1). The inlet of the gas meter is connected to the first connector 19 and the outlet is connected to the second connector 21, as shown in FIG. 1. The first fasteners 161 are then partially retightened to secure the gas meter to the meter bar assembly 112. The second pipe 23 is then rotated within space 51 to align the second end 32 of the second pipe with the service piping (97 in FIG. 1). The second pipe 23 is then connected to the service piping and the first fasteners 161 are fully retightened to secure the second pipe between the first and second members 125 and 131.

Third Embodiment

FIGS. 10-14 show an adjustable meter loop assembly according to a third embodiment of the present invention. The same reference numerals are used in the description of the third embodiment to indicate parts similar to those of the first embodiment.

As shown in FIGS. 10-14, the third embodiment of the present invention relates to an adjustable meter loop assembly 211 for a gas meter (see FIG. 1). The adjustable meter loop assembly 211 includes a first pipe 13, a second pipe 23, and a meter bar assembly 212 connecting the first and second pipes. A first member 225 is connected to first pipe 13. Second and third members 227 and 229 are connected to first member 225. An area is formed between the first, second and third members 225, 227 and 229 for receiving a second pipe 23.

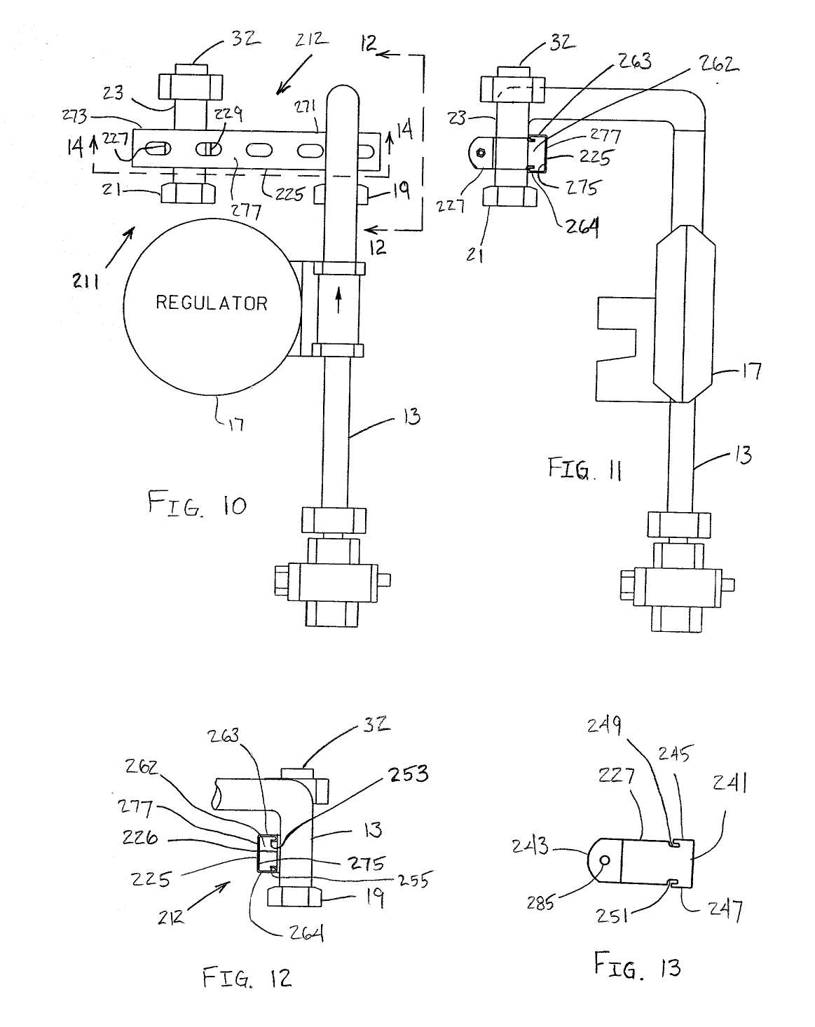

A meter bar assembly 212 connects first and second pipes 13 and 23, as shown in FIGS. 10-14. The meter bar assembly 212 includes first, second and third members 225, 227 and 229, respectively. The first member (meter bar) 225 has a first end 271 and a second end 273, and first and second opposing surfaces 275 and 277, respectively. The first end 271 of first member 225 is connected to first pipe 13. Preferably, the first member 225 is welded to a plate 226, which is welded to first pipe 13, as shown in FIGS. 12 and 14, although any suitable means of connection may be used.

Preferably, the first member 225 is a Kindorf channel, as shown in FIGS. 11 and 12. Arms 263 and 264 extend from first surface 275 of first member 225, creating a channel 262 along the first surface. Arms 263 and 264 are welded to plate 226, which is welded to first pipe 13. Ends of arms 263 and 264 have hooks 253 and 255. Preferably, the first member 225 is made of steel.

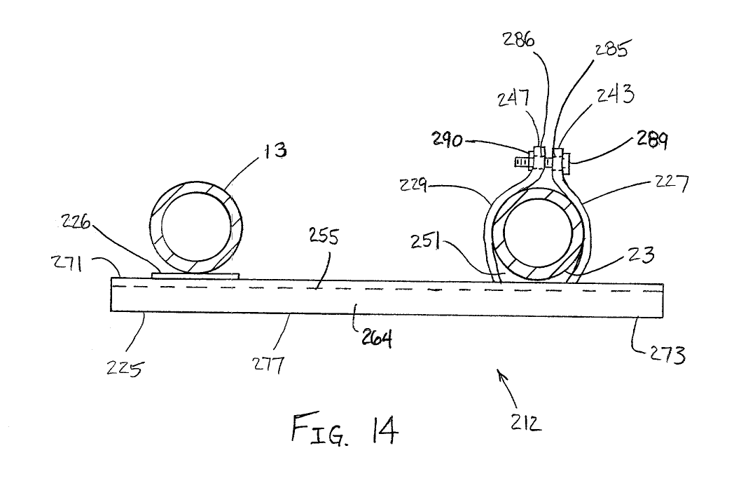

As shown in FIG. 13, second member 227 has first and second ends 241 and 243, respectively. The first end 241 of second member 227 is connected to first member 225. Tabs 245 and 247 extend from first end 241 of second member 227. Slots 249 and 251 proximal tabs 245 and 247 in second member 227 engage hooks 253 and 255 of first member 225, which prevent the second member from being withdrawn from the first member. Second member 227 has an opening 285 proximal second end 243. The third member 229 is substantially identical to second member 227.

As shown in FIG. 14, when second ends 243 and 247 of second and third members 227 and 229, respectively, are joined together, an area 251 is formed between the first, second and third members to receive second pipe 23.

The adjustable meter loop assembly 211 is shown fully assembled in FIGS. 10, 11 and 14. The first member 225 is connected to first pipe 13, preferably by welding. Slots and tabs of the second and third members 227 and 229 are engaged with the hooks of the first member 225. The second and third members 27 and 29 are moved laterally along channel 275 of first member until aligned with inlet and outlet connections on the gas meter.

The second end 243 of the second member 227 is connected to the second end 247 of the third member 229. Opening 285 in second member 227 is aligned with opening 286 in third member 229. A fastener 289 is inserted through aligned openings 285 and 286 to secure second and third members 227 and 229 together. A nut 290 may be used to facilitate securing second and third members 227 and 229 together. An area 251 is formed between the first, second and third members 225, 227 and 229. Area 251 receives second pipe 23. Tightening fastener 289 secures the second pipe 23 in the area 51 between first, second and third members 225, 227 and 229. The second pipe 23 may be rotated or moved vertically relative to the first, second and third members 225, 227 and 229 to facilitate connecting to the gas meter and to service piping by loosening the fastener 289 and nut 290.

By varying the distance between the first and second connectors 19 and 21, shown in FIG. 10, various sized gas meters may be received by the adjustable meter bar assembly 212. By loosening fastener 289 and nut 290, the second and third members 227 and 229 may be moved laterally along channel 275 relative to the first member 225 to align the first and second connectors 19 and 21 of first and second pipes 13 and 23 with the gas meter inlet and outlet, respectively. Loosening the fastener 289 and nut 290 also allows the second pipe to be adjusted vertically to align the second connector 21 with the gas meter outlet 93, as well as allowing the second pipe to be rotated and adjusted vertically to align the second end with gas service piping. The inlet of the gas meter is connected to the first connector 19 and the outlet is connected to the second connector 21. Fastener 289 is then partially retightened. The second pipe 23 is then connected to the service piping 97 and fastener 289 is fully retightened to secure the second pipe between the first, second and third members 225, 227 and 229.

While advantageous embodiments have been chosen to illustrate the invention, it will be understood by those skilled in the art that various changes and modifications may be made therein without departing from the scope of the invention as defined in the appended claims.

What is claimed is:

1. A meter bar assembly, comprising:
a first member connected to a first pipe;
a second member having first and second ends, said first end connected to said first member; and
a third member having first and second ends, said first end connected to said first member, said second end of said third member connected to said second end of said second member, an area being formed between said second and third members for receiving a second pipe.

2. A meter bar assembly according to claim 1, further comprising
at least one first opening in said first member;
at least one second opening in said second member proximal said first end;
at least one third opening in said third member proximal said first end, each said at least one first, second and third openings being aligned for receiving a first fastener.

3. A meter bar assembly according to claim 2, wherein
said at least one first opening in said first member is elongated to laterally adjust said second and third members relative to said first member.

4. A meter bar assembly according to claim 2, further comprising
a fourth opening in said second member proximal said second end; and
a fifth opening in said third member proximal said second end, said fourth and fifth openings being aligned for receiving a second fastener.

5. A meter bar assembly according to claim 1, wherein
said first member has first and second opposing surfaces, said second member is attached to said first surface of said first member and said third member is attached to said second surface of said first member.

6. A meter bar assembly according to claim 1, wherein
said first member is welded to the first pipe.

7. A meter bar assembly according to claim 1, wherein
said first member is steel.

8. A meter bar assembly according to claim 1, wherein
said first and second members have arcuate portions, said area being formed between said arcuate portions of said second and third members.

9. A meter loop assembly, comprising:
a first pipe having a first end and a second end;
a second pipe having a first end and a second end;
an inlet valve connected to said first end of said first pipe;
a first connector connected to said second end of said first pipe;
a gas regulator connected to said first pipe between said first and second ends;
a second connector connected to said first end of said second pipe; and
a meter bar assembly connected to said first and second pipes, said meter bar assembly including
a first member having first and second ends, said first end being connected to said first pipe;
a second member having first and second ends, said first end being connected to said first member; and
a third member having first and second ends, said first end being connected to said first member, said second end of said third member being connected to said second end of said second member to form an area between said first and second members, said area receiving said second pipe.

10. A meter loop assembly according to claim 9, further comprising
at least one first opening in said first member;
at least one second opening in said second member proximal said first end;
at least one third opening in said third member proximal said first end, said at least one first, second and third openings being aligned for receiving a first fastener.

11. A meter loop assembly according to claim 10, wherein
said at least one first opening in said first member is elongated to laterally adjust said second and third members relative to said first member.

12. A meter loop assembly according to claim 10, further comprising
a fourth opening in said second member proximal said second end; and
a fifth opening in said third member proximal said second end, said fourth and fifth openings being aligned for receiving a second fastener.

13. A meter loop assembly according to claim 9, wherein
said first member has first and second opposing surfaces, said second member is attached to said first surface of said first member and said third member is attached to said second surface of said first member.

14. A meter bar assembly according to claim 9, wherein
said first member is welded to the first pipe.

15. A meter bar assembly according to claim 9, wherein
said first member is steel.

16. A meter bar assembly according to claim 9, wherein
each of said first and second members has an arcuate portion, said area being formed between said arcuate portions of said first and second members.

17. A meter bar assembly, comprising:
a first member connected to a first pipe; and
a second member having first and second ends, said first end connected to said first member and said second end connected to said first member, an area being formed between said first and second members for receiving a second pipe.

18. A meter bar assembly according to claim 17, further comprising
at least one first opening in said first member;
at least one second opening in said second member proximal said first end, each said at least one first and second openings being aligned for receiving a first fastener.

19. A meter bar assembly according to claim 18, wherein
said at least one first opening in said first member is elongated to laterally adjust said second member relative to said first member.

20. A meter bar assembly according to claim 18, further comprising
a third opening in said first member proximal said second end; and
a fourth opening in said second member proximal said second end, said third and fourth openings being aligned for receiving a second fastener.

21. A meter bar assembly according to claim 17, wherein
said first member is welded to the first pipe.

22. A meter bar assembly according to claim 17, wherein
said first member is steel.

23. A meter bar assembly according to claim 17, wherein
said second member has an arcuate portion, said area being formed between said first member and said arcuate portion of said second member.

24. A meter bar assembly, comprising:
a first member connected to a first pipe; and
a second member having first and second ends, said first end connected to said first member; and
a third member having first and second ends, said first end being connected to said first member, said second end of said third member connected to said second end of said third member, an area being formed between said first, second and third members for receiving a second pipe.

25. A meter bar assembly according to claim 24, wherein
said first member is a kindorf channel.

26. A meter bar assembly according to claim 24, wherein
said second and third members are movable relative to said first member to laterally adjust said second and third members.

27. A meter bar assembly according to claim 24, wherein
said first member is welded to said first pipe.

28. A meter bar assembly according to claim 24, wherein
said first member is steel.
